(19) United States
(12) Patent Application Publication
(10) Pub. No.: US 2026/0001279 A1
(43) Pub. Date: Jan. 1, 2026

(54) Paused 3D Printing to Embed Material in a 3D Printed Case

(71) Applicant: Red Wolf Technology, Inc., Salt Lake City, UT (US)

(72) Inventor: Bradley Bacigalupi, Lehi, UT (US)

(21) Appl. No.: 19/144,835

(22) PCT Filed: Jan. 4, 2024
(86) PCT No.: PCT/US2024/010314

§ 371 Date: Jun. 30, 2025

Related U.S. Application Data
(60) Provisional application No. 63/437,328, filed on Jan. 5, 2023.
(60) Provisional application No. 63/450,524, filed on Mar. 7, 2023.

(51) Int. Cl. B29C 64/393; B29C 64/118; B29C 64/336; B29K 67/00; B29K 75/00; B29L 31/34; B33Y 10/00; B33Y 50/02; B33Y 80/00

(52) U.S. Cl. CPC B29C 64/393; B29C 64/118; B29C 64/336; B33Y 10/00; B33Y 50/02; B33Y 80/00; B29K 2067/046; B29K 2075/00; B29L 2031/3481

(57) ABSTRACT

Techniques for temporarily pausing a 3D printing operation to enable a non-printing material to be disposed in a region defined during the 3D printing operation are disclosed. A specification is accessed for a case that is to be 3D printed. Based on the specification, a 3D printer is used to fabricate an initial portion of the case. This fabrication process includes fabricating an insert region into which a non-printing material can be disposed. After at least a portion of the insert region has been fabricated, the fabrication process is temporarily paused. After the non-printing material has been disposed in the insert region, the fabrication process is resumed.

### CROSS-REFERENCE TO RELATED APPLICATIONS

This application claims the benefit of and priority to U.S. Provisional Patent Application Ser. No. 63/437,328 filed on Jan. 5, 2023 and entitled “PAUSED 3D PRINTING TO EMBED MATERIAL IN A 3D PRINTED CASE,” which application is expressly incorporated herein by reference in its entirety. This application also claims the benefit of and priority to U.S. Provisional Patent Application Ser. No. 63/450,524 filed on Mar. 7, 2023 and entitled “PAUSED 3D PRINTING TO EMBED MATERIAL IN A 3D PRINTED CASE,” which application is expressly incorporated herein by reference in its entirety.

### BACKGROUND

There are many types and variations of electronic devices used by consumers. More variations and models of electronic devices are added to the market each year. For example, Apple introduces new phones, laptops, watches and tablets at least annually. Many of these electronic devices are incredibly expensive as they house complex and delicate electronic components. Further, the electronic devices themselves are typically fragile, so protecting them is vital to maintaining the proper functioning and aesthetic look of the device. These devices keep consumers connected to their everyday world and communities, and consumers use these devices multiple times daily.

Due to their fragility, these devices are easily scratched or broken, particularly as many of the device elements contain glass pieces. Additionally, consumers are generally not conscious or careful about how they handle their devices. For example, many consumers place (or even throw) their fragile electronic devices in purses, where the devices bump against keys, pens, or other rigid items capable of scratching the glass pieces of the devices. Additionally, many consumers drop their devices onto hard surfaces (such as hardwood floors or sidewalks), which can crack or even break parts of the device. Such drops may also damage the internal electronic components if the devices are not properly protected and bumpered. Damage to the internal electronic components typically interferes with the proper functioning of the device and a consumer is forced to purchase another (very expensive) electronic device in replacement.

One way to protect these fragile and expensive electronic devices is with a case or some type of protective housing. These are often supplied by various vendors, who are required to keep numerous and varied cases in stock. For example, a typical vendor may be required to stock cases for at least Apple, Samsung, and OnePlus devices. Further, the vendor may be required to stock cases for multiple devices made by Apple, such as iPhone 6, iPhone 10, and the iPhone 12 mini, all of which require a different case. Traditional practices of storing inventory specific to particular devices are now cost-prohibitive. Maintaining a diverse inventory covering many types of devices made by different companies requires vendors to house the inventory (requiring space) and pay for it (requiring cash flow). Maintaining inventory also requires a vendor to predict how many cases for each type of device will be demanded.

Given the speed at which new electronic devices are introduced to the market, a vendor may not be able to accurately predict how many (or what kind) of cases to order and keep stocked. Further, the popularity of any one device may vary greatly, meaning a vendor may have expended a lot of time and money to keep cases stocked that are not popular. This often results in excess inventory the vendor is unable to sell off and reap a profit on. The vendor may be forced to sell the excess inventory below cost or even throw away the excess inventory to make room for new stock.

Such scenarios can generate massive waste in time and money for each individual vendor, as well as waste in materials and energy as the goods need to be shipped from the manufacturers to various vendors. This also contributes to the growing landfill as the old cases need to be disposed of and cannot generally be used with a subsequent generation of new electronic devices. What is needed, therefore, is an improved methodology for providing robust cases for electronic devices.

The subject matter claimed herein is not limited to embodiments that solve any disadvantages or that operate only in environments such as those described above. Rather, this background is only provided to illustrate one exemplary technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example architecture that can use 3D printing to fabricate a case for an electronic device.

FIG. 2 illustrates an example of a 3D printer.

FIG. 3 illustrates a scenario where the 3D printing process can be paused so that insertable materials can be inserted into a 3D printed case prior to finalization of the 3D printing process for the case.

FIG. 4 illustrates another scenario where an insertable material is being inserted into a case during the 3D printing process.

FIG. 5 illustrates another scenario where an insertable material is being inserted into a case during the 3D printing process.

FIG. 6 illustrates another scenario where an insertable material is being inserted into a case during the 3D printing process.

FIGS. 7A, 7B, and 7C illustrates an example of various printed bumpers and other embedded components.

FIG. 8 illustrates a flowchart of an example method for temporarily pausing a 3D printing operation so that an insertable material can be inserted into a case while the case is being fabricated.

FIG. 9 illustrates a case having multiple different properties and being formed of multiple different materials.

FIG. 10 illustrates the use of different protrusions to increase the surface area of a certain material and to decrease the likelihood of delamination.

FIG. 11 illustrates a different set of protrusions.

FIG. 12 illustrates various characteristics of the protrusions.

FIGS. 13A, 13B, 13C, and 13D illustrate a drop-in member.

FIG. 14 illustrates an example computer system that can be configured to facilitate the various operations disclosed herein.

### DETAILED DESCRIPTION

Embodiments disclosed herein relate to systems, devices, and methods for temporarily pausing a three-dimensional (3D) printing operation to enable a non-printing material to be disposed in a region defined during the 3D printing operation.

Some embodiments access a specification for a case that is to be 3D printed. Based on the specification, the embodiments cause a 3D printer to use printing material to fabricate an initial portion of the case. This fabrication process includes fabricating an insert region into which a non-printing material can be disposed. After at least a portion of the insert region has been fabricated, the embodiments temporarily pause the fabrication. The embodiments then determine that the non-printing material has been disposed in the insert region. After the non-printing material has been disposed in the insert region, the embodiments resume the fabrication of the case.

Resuming the fabrication of the case can optionally include fully enveloping the non-printing material with the printing material. In other implementations, resuming the fabrication of the case includes printing the case in a manner such that at least a portion of the non-printing material is exposed and such that the non-printing material is not fully enveloped by the printing material.

### Examples of Technical Benefits, Improvements, and Practical Applications

The following section outlines some example improvements and practical applications provided by the disclosed embodiments. It will be appreciated, however, that these are just examples only and that the embodiments are not limited to only these improvements.

The disclosed embodiments provide significant improvements, benefits, and practical applications to the technical field of 3D printing and case fabrication. In particular, the embodiments utilize various 3D printing techniques to fabricate a case, such as a case for an electronic device. Notably, the embodiments are beneficially designed to temporarily pause the 3D printing process to enable a non-printing material to be disposed in a region that has been partially printed during the 3D printing process.

Some non-limiting examples of a non-printing material include, but certainly are not limited to, any type of buffer material, elastomeric material, memorabilia material, or even electronic circuitry. After the non-printing material has been disposed in the defined region, the 3D printing process will resume.

By temporarily pausing the 3D printing process and by printing a region into which non-printing material can be disposed, the embodiments are able to improve how cases are fabricated. Depending on the type of material used as the non-printing material, the embodiments can significantly increase the durability and protective qualities of the case. The embodiments can also enable the case to perform other operations, including operations related to the use of electronic circuity.

For instance, a bank or credit card can be protectively embedded in the case. The card is now protected and possibly even entirely hidden from the public eye while still being usable via near field technology. Accordingly, these and many other benefits will now be described in more detail throughout the remaining portions of this disclosure.

### Example Architecture

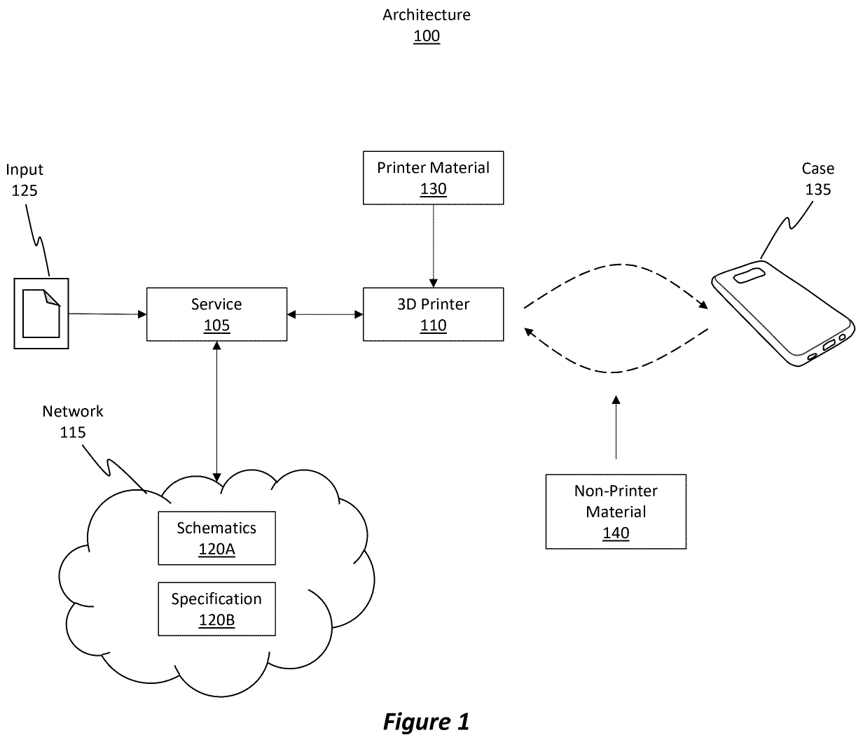

Having just described a few of the benefits provided by the disclosed embodiments, attention will now be directed to FIG. 1, which illustrates an example architecture 100 that can be used to achieve the disclosed benefits. Architecture 100 is shown as including a service 105. As used herein, the term “service” generally refers to an on-demand, self-processing application that is tasked with performing various operations. Service 105 can optionally be a cloud-based service operating in a cloud. Service 105 can also optionally be a local service operating on a local device. In some instances, service 105 can be a hybrid capable of performing both cloud-based operations and local operations.

Service 105 is tasked with controlling various operations in order to generate, via 3D printing processes, a case, such as a case for an electronic device. To do so, service 105 can communicate and/or control a 3D printer 110.

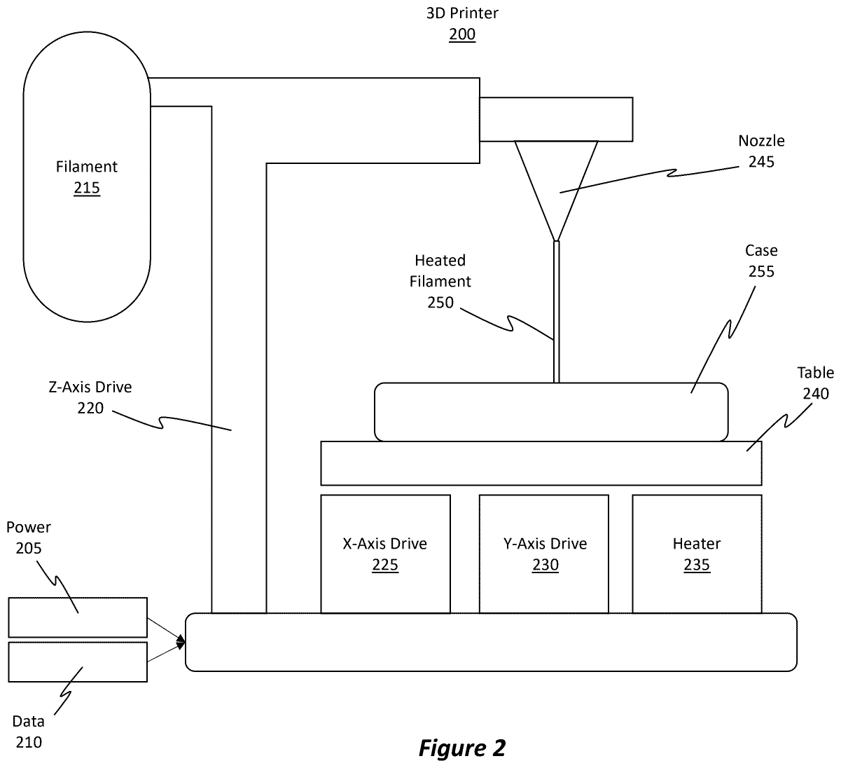

As used herein, the phrase “3D printer” refers to a device that is capable of printing or performing additive manufacturing to make a three-dimensional (3D) solid object based on specifications provided in a digital file. FIG. 2 provides additional details regarding an example 3D printer.

FIG. 2 shows a 3D printer 200, which is representative of the 3D printer 110 of FIG. 1. 3D printer 200 is shown as including a power source 205 or as being connected to a power source. 3D printer 200 is also provided input in the form of data 210. For instance, the data 210 can be provided to the 3D printer 200 from the service 105 of FIG. 1. The data 210 can be a specification for a device and how to fabricate the device using 3D printing instructions.

3D printer 200 uses 3D printing material called a filament 215 to fabricate a solid object. The filament 215 can be comprised of any type of material suitable for 3D printing purposes. In some instances, the filament 215 is comprised of a single type of material. In other instances, multiple different materials can be used as the filament 215. During the printing process, the 3D printer 200 can thus use multiple different types of materials to 3D print an object.

3D printer 200 includes a z-axis drive 220, an x-axis drive 225, and a y-axis drive 230 to enable the 3D printer 200 to print along the three different coordinate axes. 3D printer 200 also includes a heater 235 that can be used to maintain heat on the object being printed and/or on the filament 215. 3D printer 200 is also shown as including a table 240 on which the printed object will rest. 3D printer 200 also includes a nozzle 245 through which the heated filament 215 passes in order to progressively build up the object, as shown by the heated filament 250 emerging from the nozzle 245. The heated filament 250 is used to progressively build the object, which can optionally be a case 255 for an electronic device.

Returning to FIG. 1, the service 105 is able to control the 3D printer 110. Optionally, the service 105 can access a network 115 to obtain schematics 120A that pertain to a specific type of electronic device for which a case is being printed. The schematics 120A describe the various dimensions and characteristics of an electronic device.

The service 105 can also access a specification 120B for a case that is to be 3D printed for the device. The specification 120B includes all the various different dimensions, features, and characteristics for the case.

The service 105 can further receive input 125 from a user to further clarify various features or attributes of the case that is to be printed. Optionally, the input 125 can be used to customize or modify the specification 120B for the case so that a customized case can be fabricated.

FIG. 1 shows how printer material 130 (e.g., the filament mentioned in FIG. 2) can be provided to the 3D printer 110. This printer material 130 is used to print a case 135.

In accordance with the disclosed principles, the embodiments are able to dynamically pause the 3D printing process for a defined period of time to allow a non-printer material 140 (aka non-printing material) to be inserted into the case 135 while the case 135 is being printed by the 3D printer 110.

The non-printer material 140 can, for example, be additional support material designed to improve the protective qualities of the case 135. As one example, the non-printer material 140 can be a type of elastomeric material that is inserted into a groove or insert formed during the printing process. The electronic device can abut this elastomeric material, and the material can operate as a buffer or shock absorber, particularly when the device is dropped. As another example, the non-printer material 140 can be a rigid support material, possibly designed to reinforce the strength or durability of a side wall of the case 135.

Optionally, the non-printer material 140 can be a different type of material that perhaps does not operate to provide protection but that performs a different function. As an example, the non-printer material 140 can be or can include electronic circuitry, such as perhaps an RFID chip or some other type of circuit. Even a credit or debit card can be used as the non-printer material 140.

In some cases, the non-printer material 140 can be selected or customized by a user. In some cases, the non-printer material 140 might not have utility purposes but rather might have emotional purposes. As an example, the non-printer material 140 can be a memorable token of the user (e.g., a gold strip, a patch of hair, etc.). Indeed, the non-printer material 140 can be any type of material that is different from the printer material 130.

After the non-printer material 140 is inserted, perhaps into a printed groove, the 3D printing process can resume. In some cases, a portion of the non-printer material 140 may at least be partially exposed on the case 135. In other cases, the non-printer material 140 is entirely enveloped by the printer material 130, resulting in no portion of the non-printer material 140 being visible or exposed.

As an example, if the non-printer material 140 were an RFID chip, it may be desirable to fully cover the RFID chip by the printer material 130. The RFID chip can still be utilized by placing the RFID chip at a location proximate to an RFID reader. As another example, a credit card can be embedded in the case 135. The credit card is still usable using near field technology. Now, however, the credit card is protected from easily being stolen by the simple fact that it is not visible.

### 3D Printed Insert Channels in a Case

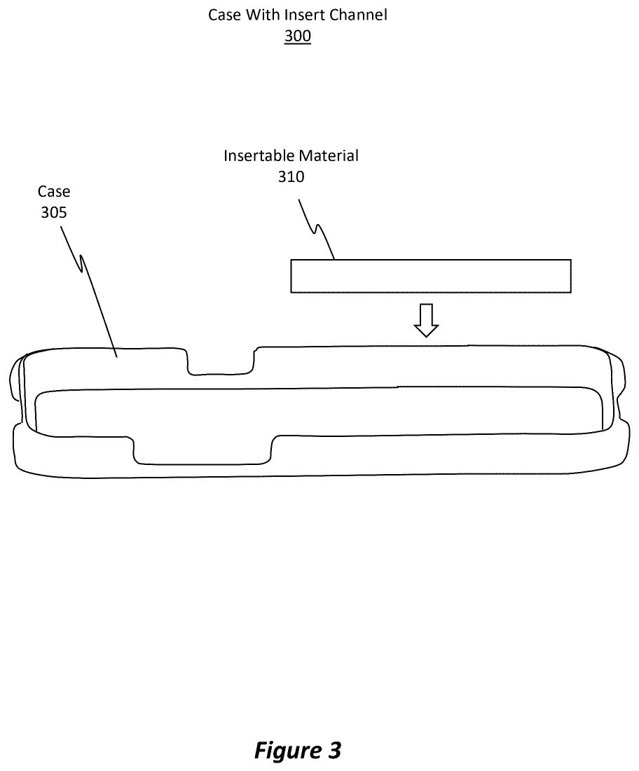

FIG. 3 shows an example case with an insert channel 300. In particular, FIG. 3 shows a case 305 that includes a printed insert into which an insertable material 310 (e.g., the non-printer material mentioned earlier) can be placed. By “printed insert” it is meant that the 3D printer printed a cavity, hollow portion, hole, recess, or otherwise partially exposed region into which another material can be disposed.

In most scenarios, the insertable material 310 is inserted or placed into the insert during a pause period in which the 3D printing process has been paused for a period of time. In such a scenario, the insertable material 310 can then subsequently be entirely enveloped or covered by printing material or, alternatively, can be at least partially enveloped or covered by the printing material. In some cases, the printing material can be additively placed in a manner so that the insertable material 310 is permanently fixed at a particular location after the fabrication process is complete. In some cases, the printing material can be placed in a manner so that the insertable material 310 is still removable from the insert after the fabrication process is complete.

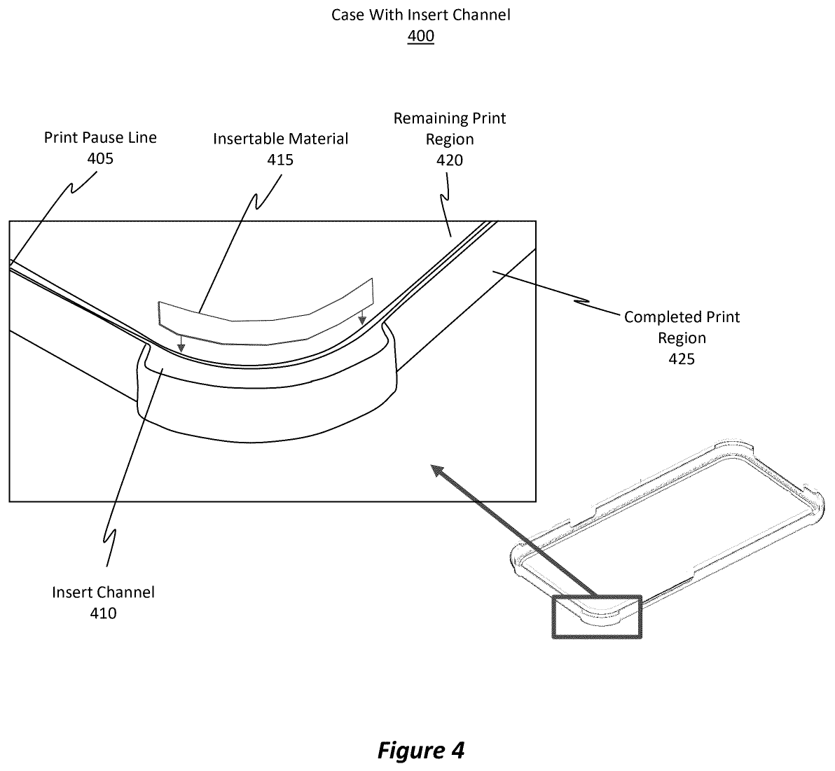

In some scenarios, the insertable material 310 is inserted or placed into the insert after the 3D printing process has finished. In such a scenario, the printing material is additively placed in a manner such that the insertable material 310 is insertable and removable from the printed insert region even after the fabrication process is complete. FIGS. 4, 5, and 6 provide additional details regarding the printing process.

FIG. 4 shows a case with an insert channel 400. In particular, FIG. 4 shows a print pause line 405, where the 3D printer has been temporarily halted or paused in its printing operations. FIG. 4 also shows a partially completed printed insert channel 410, which is a hollow region that has been defined or printed by the 3D printer by partially building up walls around a hollow region. In this scenario, the insert channel 410 is only partially complete. FIG. 4 also shows an insertable material 415 that is not yet placed in the insert channel 410.

As mentioned previously, the insertable material 415 (e.g., the non-printer or non-printing material) can be any type of material. Such materials include, but certainly are not limited to, any type of elastomeric material, electronic circuitry, rubber, hard plastic, memorabilia material, and so on, without limit. In some cases, the non-printing material is a radio frequency (RF) component. In some cases, the non-printing material is an RF blocking component. In some cases, the non-printing material is an RF enhancing component (e.g., perhaps an antenna). The non-printing material can be a cushioning material, such as air, gel, or some other cushion.

In some implementations, the insert region is one of multiple regions. Optionally, the pattern of these insert regions can be of any pattern, including a honeycomb pattern. Thus, the case can be printed using multiple different material types, including a more rigid type and a more flexible type or even a cushioning type.

FIG. 4 further shows a remaining print region 420 and a completed print region 425. The 3D printing process is typically temporarily paused to enable the insertable material 415 to be inserted into the insert channel 410. After the insertable material 415 is inserted into the insert channel 410, the 3D printing process is resumed. The insertable material 415 can then be fully or at least partially enveloped by additional printing material that is added to the case as a part of the 3D printing process.

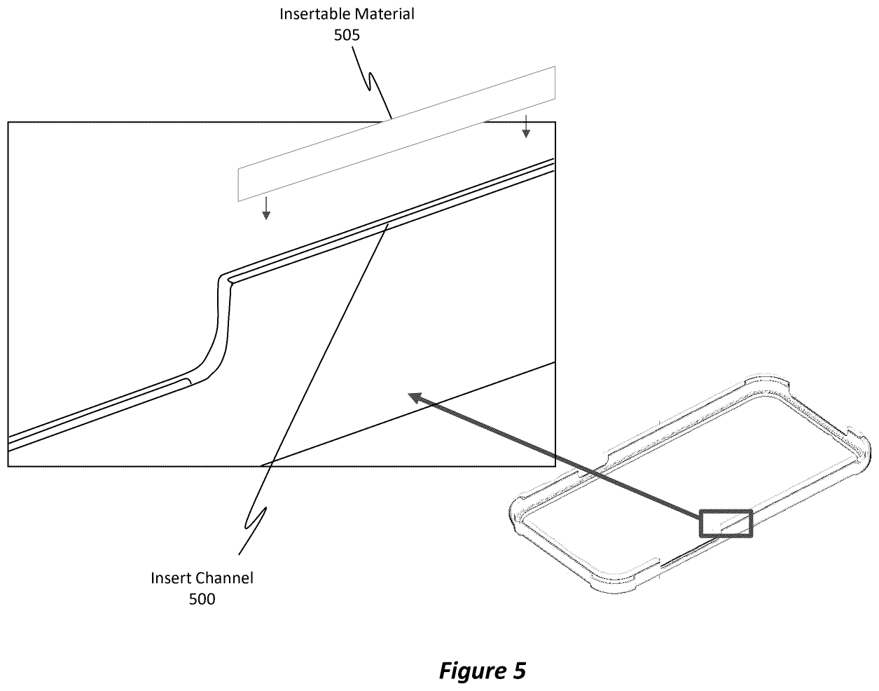

FIG. 5 shows another viewpoint of an insert channel 500. Here, an insertable material 505 is being shown as being inserted into the insert channel 500 while the 3D printing process has been temporarily paused.

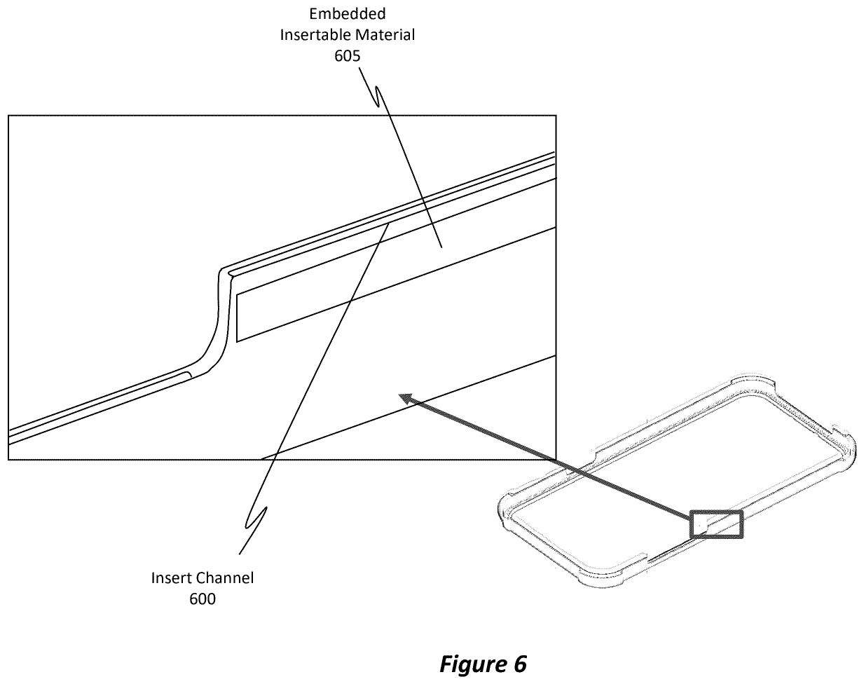

FIG. 6 shows another viewpoint of the insert channel. Here, however, the insertable material has been inserted or embedded into the insert channel 600, as shown by embedded insertable material 605. Furthermore, additional printing material has been added to the case and is now fully covering or enveloping the embedded insertable material 605. In this example scenario, no portion of the embedded insertable material 605 is visible from an external inspection of the case. In some cases, a portion of the embedded insertable material 605 can optionally remain visible depending on how the remaining printing material is added to the case. For instance, a window can be printed to allow the insertable material to be at least partially visible.

By inserting material of a different type than the printing material into a defined groove, recess, hollow portion, or insert of the case, various benefits can be achieved. For instance, structural reinforcement material can be added to further strengthen the case. Protective material, such as rubber or soft plastic, can be added to help provide a buffer or shock absorption for the electronic device when the device and case are dropped. Other materials can be used to provide other benefits, such as electronic circuity. Accordingly, by temporarily pausing the 3D printing process to allow an insertable material to be disposed within an internal confines of the case, significant benefits can be provided by the disclosed embodiments.

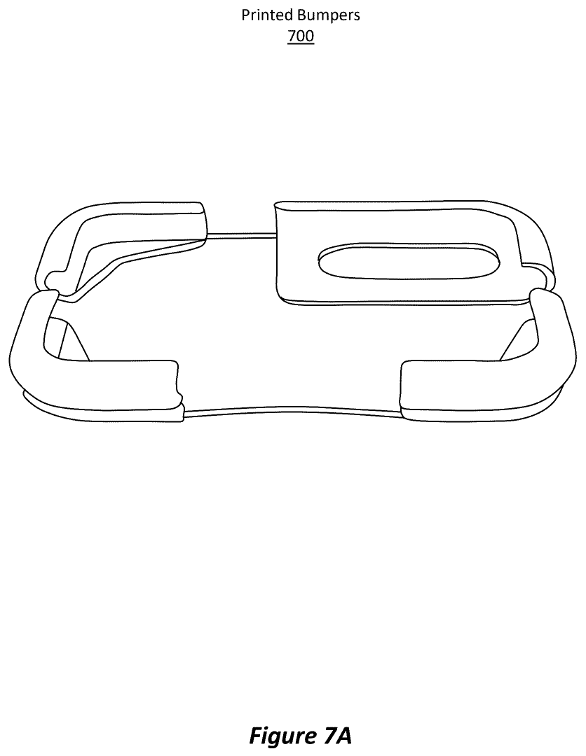

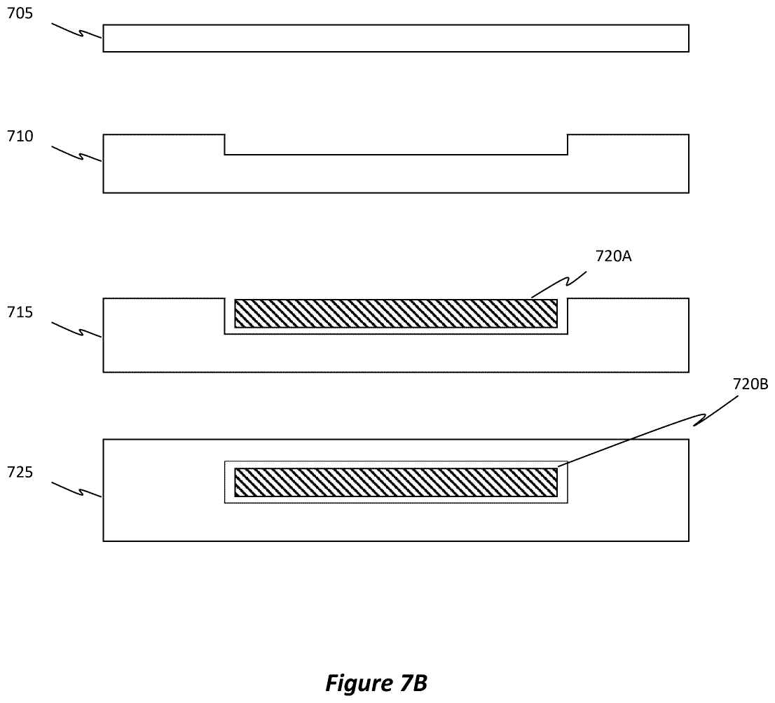

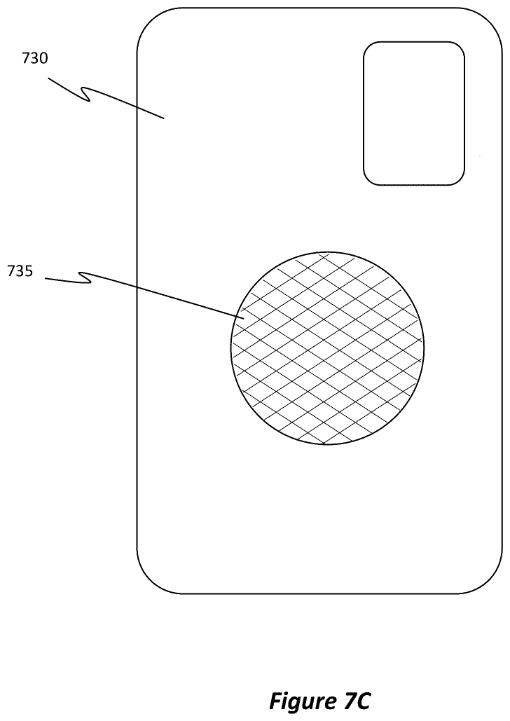

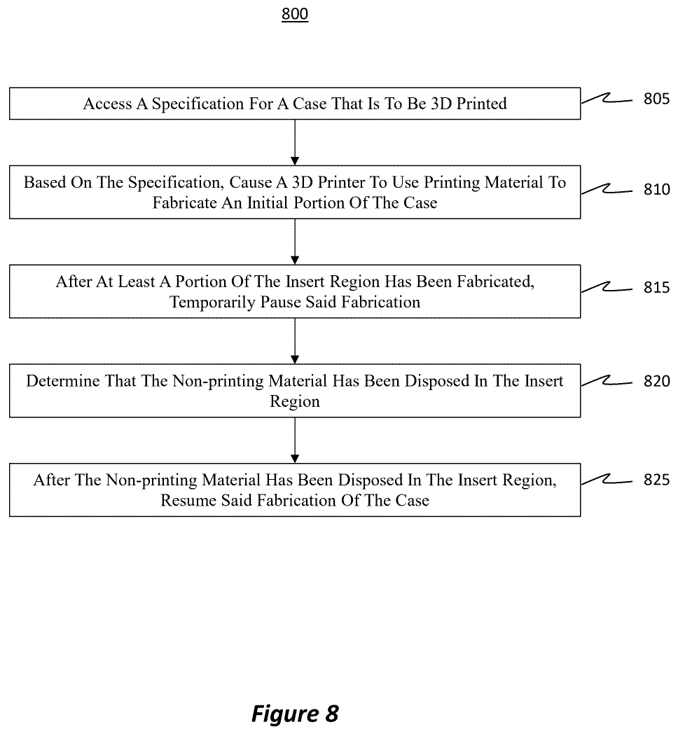

The disclosed embodiments are able to generate other types of features as well, such as the printed bumpers 700 of FIG. 7A. These printed bumpers 700 can optionally be added to the corners of a device or of a case to provide further protection.

FIG. 7B shows an example scenario where a component can be embedded in the case at an area that is different than the side walls. For instance, a component can be embedded in the large, planar region of the case. FIG. 7B shows a side view of a case that is progressively being printed.

To illustrate, FIG. 7B shows a case 705 that is currently being printed, layer by layer. Case 710 shows a scenario where a bump out or hollow region is currently being formed by the additive printing process. Case 715 shows a scenario where the bump out is sufficiently deep now to allow a component 720A to be placed in the bump out. Case 725 shows a scenario where the component 720B is now fully covered by material from the printing process.

FIG. 7C shows a case 730 with an embedded component in the large, planar region of the case 730. Currently, a patchwork of material 735 is being printed on top of the material to form a frame for subsequently fully covering the component with the printing material. Accordingly, the disclosed embodiments allow for components to be embedded in any part of case, including the side walls and/or the large, planar region of the case.

It should be further emphasized how any type of component can be embedded in the phone case. Examples of such components include, but certainly are not limited to, any type of magnetic component or electromagnetic component. Components can use inductor technology to act as a charging or charged unit. Components can include circuitry and/or any type of radio frequency device.

In some implementations, the embodiments print a void in the case. The printing process is then paused. A different substance can then be injected into the void. For instance, the embodiments can inject a hot plastic or some other malleable material that fills up the void. The embodiments can then continue the printing process, thereby covering the injected material, which now fills the void.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

Attention will now be directed to FIG. 8, which illustrates a flowchart of an example method 800 for temporarily pausing a three-dimensional (3D) printing operation to enable a non-printing material to be disposed in a region defined during the 3D printing operation. Method 800 can be performed within the architecture 100 of FIG. 1. Furthermore, method 800 can be implemented by the service 105 and/or the 3D printer 110 of FIG. 1.

Method 800 includes an act (act 805) of accessing a specification for a case that is to be 3D printed. The specification details the various dimensions, characteristics, and features of the case that is to be 3D printed.

Based on the specification, act 810 includes causing a 3D printer to use printing material to fabricate an initial portion of the case. This fabrication process includes fabricating an insert region into which a non-printing material can be disposed.

After at least a portion of the insert region has been fabricated, act 815 includes temporarily pausing the fabrication operation. For instance, FIG. 4 shows an insert channel 410, which can be an example of the insert region mentioned in acts 810 and 815. In this scenario, the insert channel 410 is incomplete in that the insert channel has not been fully formed. This is because an insertable material will subsequently be disposed inside of the insert channel 410. The insert channel will later be further built up or fabricated to completion, with the insertable material disposed therein.

Act 820 includes determining that the non-printing material has been disposed in the insert region. For instance, the embodiments can include a camera that monitors the insert channel. The embodiments can analyze the resulting imagery to determine if the insertable material is properly disposed in the insert channel. If the insertable material (i.e. the non-printing material) is properly disposed, then the embodiments can resume the fabrication process.

In another embodiment, a user can provide input to the embodiments to inform the embodiments that the non-printing material has been inserted into the insert channel. In some cases, the non-printing material is manually placed in the insert channel. In other cases, the non-printing material is automatically placed in the insert channel, perhaps even by the 3D printer.

For instance, the nozzle of the 3D printer can optionally navigate to a location where the non-printing material is stored. The nozzle can then deposit a small amount of the printing material onto the non-printing material to act as an adhesive to temporarily bind the non-printing material to the nozzle. The nozzle can then navigate, with the non-printing material, to the insert channel. The nozzle can then place the non-printing material into the insert channel and resume the 3D printing process with the non-printing material disposed in the insert channel.

After the non-printing material has been disposed in the insert region, act 825 includes resuming the fabrication of the case. In some implementations, the process of resuming the fabrication of the case includes causing the 3D printer to fully envelope the non-printing material with the printing material. In some implementations, the process of resuming the fabrication of the case includes causing the 3D printer to print the case in a manner such that at least a portion of the non-printing material is exposed and such that the non-printing material is not fully enveloped by the printing material.

Accordingly, the disclosed embodiments temporarily pause a 3D printing operation to enable a non-printing material to be disposed in a region that has been partially printed and that has been designed to house the non-printing material. Doing so provides numerous benefits, as described herein.

### Additional Embodiments

Some embodiments disclosed herein further enable for the stitching or merging of different types of materials together so that those materials do not delaminate. Examples of such materials include, but are not limited to, a soft and flexible material being stitched together with a rigid and hard material. For instance, during the 3D printing process, a hard filament can be caused to reach through a soft filament, or vice versa, to thereby create a stitched material similar to a zipper-like configuration. This unique printing process can be performed anywhere on the case, such as on the corners, on any of the planar regions, or on any of the sides.

The stitching of one material having a first hardness or flexibility level (e.g., a relatively soft hardness) with a second material having a second hardness or flexibility level (e.g., a relatively hard hardness) is performed for a variety of reasons. One reason is to reinforce various portions of the case so as to better protect the handheld device.

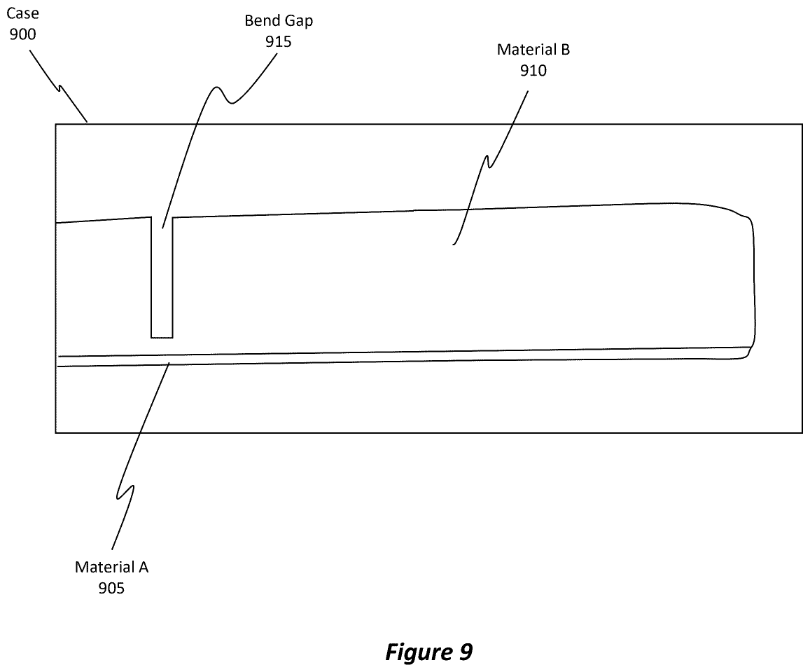

Another reasons is to improve the printing process. For instance, from various testing scenarios, it has been found that a softer material is significantly harder to remove from the print bed after the printing process has completed. By printing an initial, hard layer and then subsequently printing softer layers on top of that hard layer, the ability to remove the case from the print bed is significantly easier and thus improves the printing process. FIG. 9 is illustrative.

FIG. 9 shows a case 900 that is formed of a first material A 905 (e.g., perhaps a material called Poly-L-Lactic acid (“PLLA” or just “PLA”) or some similar material) and a second material B 910 (e.g., perhaps thermoplastic polyurethane (“TPU”) or some similar material). Material A 905 is comprised of a harder material than material B 910. Furthermore, material A 905 is the initial layer that is disposed on the printing bed. By disposing this harder material first on the printing bed, the subsequent removal of the case 900 from the printing bed is made significantly easier.

Case 900 is also shown as including a bend gap 915 (aka a relief notch) disposed in the sidewall region of the case 900. The bend gap 915 is provided to enable the flexing or bending of the case 900 when positioning the case 900 on a handheld device. By omitting material from the side wall, as shown by the bend gap 915, the case 900 can more easily flex and bend when being positioned onto the handheld device.

Any number of bend gaps or relief notches can be included in the case. Furthermore, these relief notches can be disposed anywhere on the case. For instance, one or more relief notches may be disposed on each side wall segment of the case. In some scenarios, the case might have two relief notches, one on each long side wall portion. In some scenarios, the case might have four relief notches, one on each long side wall portion and one on each short side wall portion.

If the charging port area is left open, however, then some embodiments avoid including a relief notch on the smaller side wall portions. These relief notches enable the case to be more flexible when inserting the handheld device into the case or when removing the handheld device from the case. The size of the relief notches can vary. Often, the size is between about 0.1 mm and about 0.5 mm.

Accordingly, some embodiments are structured to have a rigid or hard material on the back portion of the case and then a softer or flexible material on the inside of the back of the case. For instance, notice how material B 910 is disposed on top of material A 905 in FIG. 9.

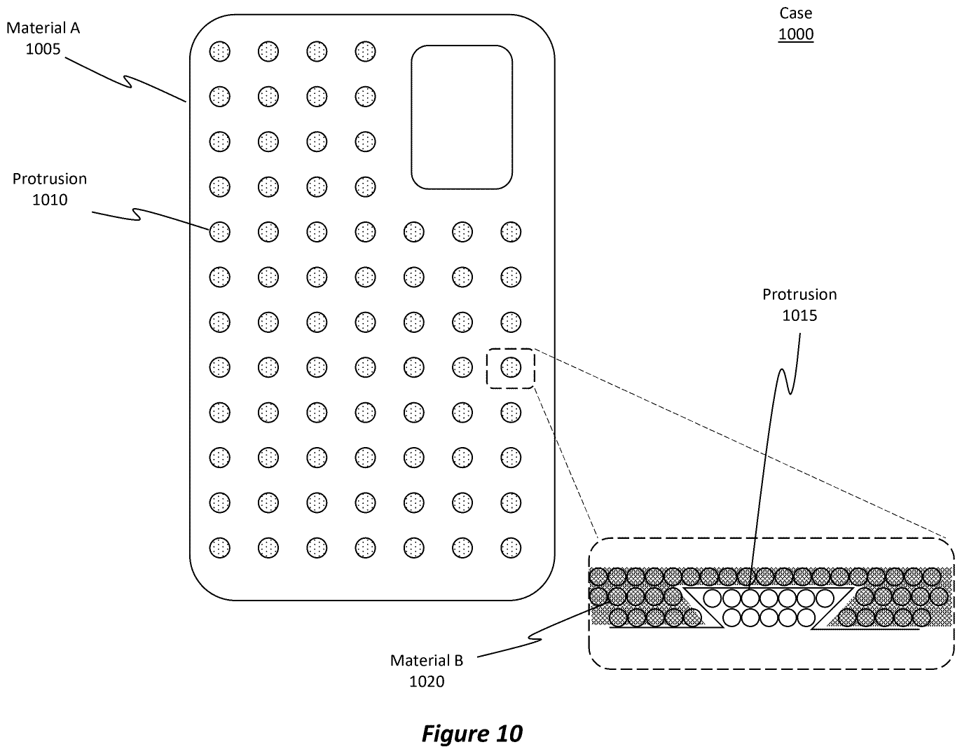

FIG. 10 shows another case 1000 that has an initial base layer formed of the harder material A 1005, as discussed in connection with FIG. 9. To facilitate the stitching or merging of material A 1005 with the softer material (e.g., material B from FIG. 9), some embodiments form protrusions (either concave protrusions or convex protrusions), as shown by protrusion 1010. In some scenarios, the protrusion 1010 can be in the form of a bump-out or a bump-in. Although the protrusion 1010 is shown as being in the shape of a circle, any shape can be used. The arrangements of these protrusions can be formed into any configuration, such as a honeycomb pattern or any other pattern.

These protrusions provide additional surface area for material B to be disposed on top of material A 1005, thereby enabling those two materials to be “stitched” together. Some embodiments increase the surface area through the use of ribbing or cross-stitching patterns when material A is printed. Some embodiments include more or less protrusions than what is shown in FIG. 10. Some embodiments include protrusions only on the outer border or edge of the case 1000. It is often the case that near the edges or borders of the case, there is a higher likelihood of delamination. Use of the disclosed printing techniques to produce the protrusions, however, helps to lower or even eliminate that risk, particularly around the edges/borders.

When material B is printed on top of material A 1005, more contact can be made between the two materials as a result of the increase in surface area provided by the protrusion 1010. This type of printing helps avoid material B from delaminating from material A 1005.

FIG. 10 shows another depiction of a protrusion 1015, this time from a side view. Some embodiments print the protrusion 1015 in an angled manner, as shown, so that when the softer material is printed on top of the harder material (as shown by the various circles), some of the softer material will be positioned underneath the angled portion, thereby locking the softer material in place and preventing the two materials from delaminating.

For instance, material B 1020 is shown as at least partially being positioned (during the printing process) under the angled portion of material A, thereby locking the two materials in place. It should be noted how the 3D printer switches filaments during the printing process in order to achieve these embodiments. To be clear, it is typically not the case that the embodiments print all of material A and then return to print material B underneath the angled portion of material B. Rather, the embodiments form a first layer of material A, then switch filaments to then print (at the same layer) material B. The embodiments then switch filaments again to print (a next layer) of material A. Accordingly, in some cases, the embodiments are able to print dove-tailed interlocking protrusions and are able to alternate the printing of different filament types, even on the same print layer.

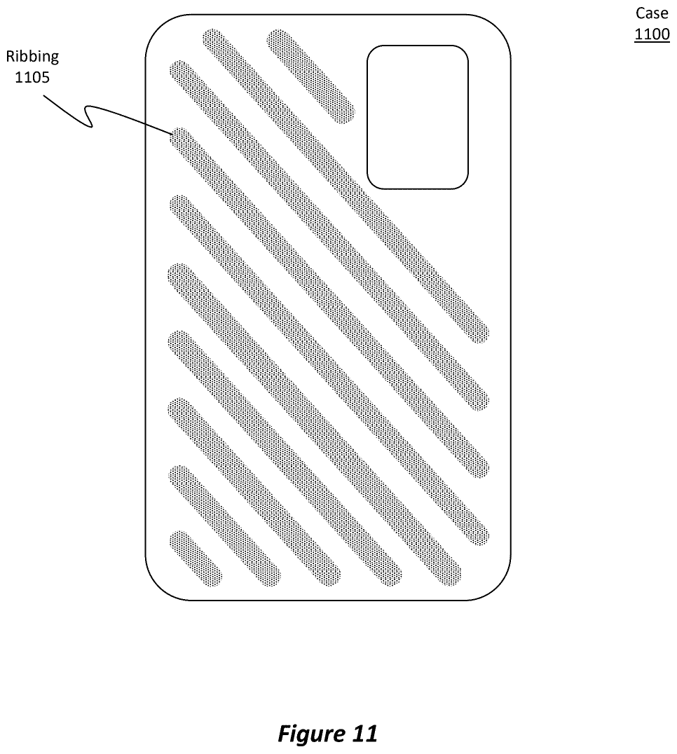

FIG. 11 shows another case 1100. Case 1100 includes ribbing 1105 (e.g., a different configuration of the protrusions mentioned above). Ribbing 1105 is also formed of the harder material. This ribbing can be thought of as a type of corduroy deposition of material.

The depth of the protrusions can be set to any value. Often, the depth of the protrusions is about 0.4 millimeters (mm). In some cases, the depth can be within the range of 0.1 mm up to about 0.6 mm. In some cases, the depth of each protrusion is the same while in other cases, the depths of different protrusions might be different. For instance, a depth of an outer or border protrusion might be 0.4 mm while the depth of an inner protrusion might be 0.2 mm. In some cases, the depth of the protrusion can be one layer high (e.g., one layer of printed filament), two layers high, or perhaps even three layers high. In preferred embodiments, the depth is at least two layers high.

Although the speed of the printing process may be reduced as a result of printing these protrusions, the overall quality of the resulting case will be improved because the likelihood of the materials delaminating is reduced. Thus, the minor reduction in speed is often worthwhile in order to achieve an improved case.

The embodiments are able to use different materials to print different portions of the case. For instance, it might be the situation that the case's outer corners are printed using the harder filament material. The inner portion of the case's corners might be printed using the softer material.

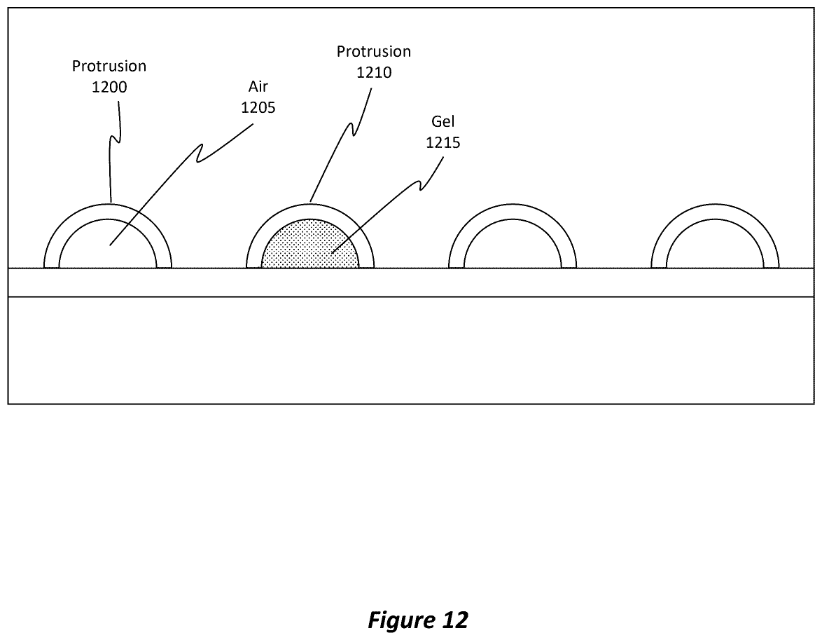

In some cases, the printing process can involve printing bubbles or open air cushions on the case. For instance, FIG. 12 shows a protrusion 1200 that is printing using the disclosed printing techniques. In one scenario, the protrusion 1200 is printed in a manner so as to encapsulate or envelope air 1205, thereby forming an air pocket. In some cases, the resulting pocket that is formed is an air-tight pocket. In other cases, the pocket might not be air-tight but might be a slow deflating/inflating pocket.

In other scenarios, the protrusion 1210 is printed so as to cover some kind of gel 1215 or cushion material. These types of protrusions can help provide additional protection for the handheld device. The position of these air pockets can be selected so as to maximize protection for the handheld device when the device is fitted in the cover. In some scenarios, the air (or gel) pockets are formed on the case near the corners or border regions. In some scenarios, a sparse grouping of air pockets can be disposed on the planar regions of the case. In some scenarios, the pocket can be filled with some type of buoyant material (or air) so that the case (by itself) might float if left in water.

Optionally, a void in the case can be formed during the printing process, and this void can be filled with a cushion-like material, such as perhaps a gel or some other cushioning material. The void can optionally be formed in the corner regions of the case. In some cases, the void can be filled during the printing process, such as by swapping filaments, or the void can be later filled, even after the printing process is complete.

Different patterns for the air pockets can also be used during the printing process. For instance, one pattern may be used for the larger planar regions and a different pattern of the air pockets can be used for the corners or smaller planar regions (e.g., the side walls).

Some embodiments can also be printed in a manner so that the case has integrated sleeves or pockets that can be filled with various artifacts. As one example, the back of the case can be printed in a manner so that a credit card sleeve is formed and is an integral part of the case.

In some scenarios, the case can be printed in a manner so as to form clip-on interfaces or portions to enable clip-on attachments to be attached to the clip-on interface. For instance, the clip-on interface might include a clasp or interlocking member that enables an external artifact to be clipped or otherwise coupled to the case. In some scenarios, the case can be printed in a manner so as to include a tether feature or a holster feature to allow other artifacts to be coupled to the case. Thus, any type of clip feature can be integrated with the case, thereby allowing external clippable features to be clipped to the case.

As one specific example, the case can be printed in a manner to include a clip-

on feature. This clip-on feature might enable the device to be attached to other structures, such as perhaps a tripod or a hanger on the wall or some other clip. In some cases, the case can be printed in a manner so as to include a finger gripping component on the back portion of the case to enable users to better hold the case and device combination. Optionally, this finger gripping component can be telescopic or retractable in some manner.

Some embodiments are configured to enable the case to receive insertable material, such as padding, felt, or leather. The overall system can include a complementary machine that can cut the insertable material while the case is being printed. The insertable material can then be inserted into whatever section of the case has been designed to receive that material. These insertable materials can provide additional protection for the handheld device. They can also provide a nice aesthetic look or feel to the case.

Additionally, the insertable material can be used to accommodate different tolerances that might be present as a result of using different 3D printers. That is, if the tolerance of one 3D printer is slightly different, resulting in a larger printed section, the insertable material can be used to help fill in that section, thereby accommodating the difference in tolerances. In some scenarios, the insertable material can optionally be placed on the inside portion of the case. Thus, ornamental or functional material (e.g., padding) can be used. Such materials can also help avoid a scenario where the case might scratch the handheld device as a result of the case being too tight or too rigid. Additionally, if there is a slight gap or play between the device and the case, dust, debris, or other particles might find their way into the gap regions and might scratch the device. Using this insertable material, however, helps fill in those gaps, thereby preventing debris from entering.

Using the disclosed printing techniques, the embodiments can also accommodate devices that fold or that have a hinge of some sort. That is, the case for the device can also be manufactured in a manner so as to include a foldable portion or a hinge-like portion. Thus, the case will not impede the device's own ability to fold.

Optionally, the case can be designed to include additional antenna-like structures for the handheld device. Additionally, or alternatively, the case can be designed to act as a Faraday cage to block some or all of the radio frequency (RF) transmissions of the handheld device. For instance, the case can include embedded features to operate as antennae or, alternatively, RF blockers. Thus, the printing techniques can include various geometries for embeddable features to facilitate RF enhancement or RF blocking.

Some filaments used during the printing process can have thermal properties to help dissipate heat that might be generated by the handheld device. For instance, suppose the handheld device is a type of gaming device. It is often the case that gaming devices heat up quickly and remain hot for extended periods of time.

Some embodiments utilize graphing filaments or other filament types that have rapid heat dissipation properties to help keep the device cool or to help it cool off faster relative to conventional cases. Some of the cases can be designed to include heat sinks, such as fins of some sort to allow the heat to sink to that region of the case and to then quickly dissipate into the atmosphere. Some embodiments can utilize a graphene or copper infused filament to operate as a heat sink, and these heat sinks can be printed (or a void for the insertion of those heat sinks can be printed) using the disclosed techniques.

Regarding the printing process, some embodiments utilize a tool called a slicer. This slicer tool allows a case designer to design different layers that can subsequently be stacked on top of one another. The slicer can provide a solid object slice, and then any number of additional pattern slices (e.g., honeycomb patterns, interweaving patterns, etc.), color slices, input decisions, additional solid slices, or other object slices can be overlaid onto the solid object slice. The slicer tool converts the resulting design into mathematical G code that instructs the 3D printer on how to print, including when to switch colors, where to print, where and which filament to use, and so on.

The same handheld device might have many differently designed cases. The disclosed embodiments can maintain a repository of case designs and those designs can be used at any time. When a new design is created, it can be stored in the repository.

When multiple designs are available, historically it has been a challenge to make updates to those cases. Using the disclosed slicer tool, however, the embodiments can significantly improve the update process, resulting in significant efficiency improvements. To do so, some embodiments are able to identify the center of the case design using the numeric G code pattern. One or more new layers can then be automatically aligned with the existing layers based on the identification of the center portion. These new layers can then be incorporated into a case design in a quick and easy manner via this alignment process. Thus, the embodiments are able to overlay and automate the generation of new designs in a quick and efficient manner.

Using these techniques, global updates to multiple different case designs can also be performed in an automatic manner. That is, using the determined center of the case design, the embodiments can automatically incorporate modified designs by modifying layers/slices and then aligning and propagating the pattern using these mathematical G code alignment operations. Thus, updates can be easily propagated in a quick and efficient manner, even global updates. As a result, any number of new case designs can be created.

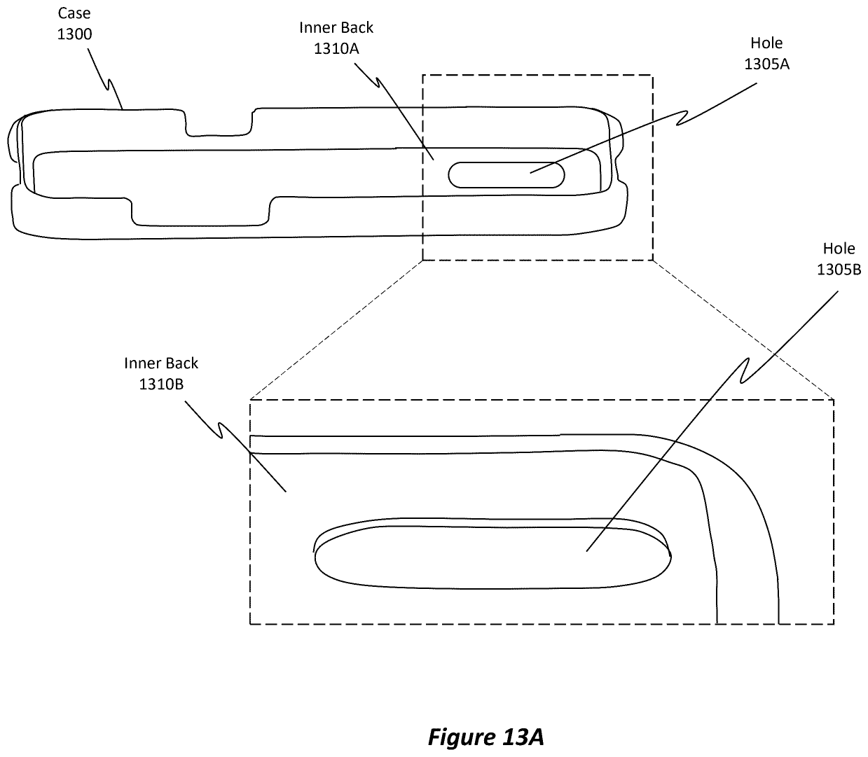

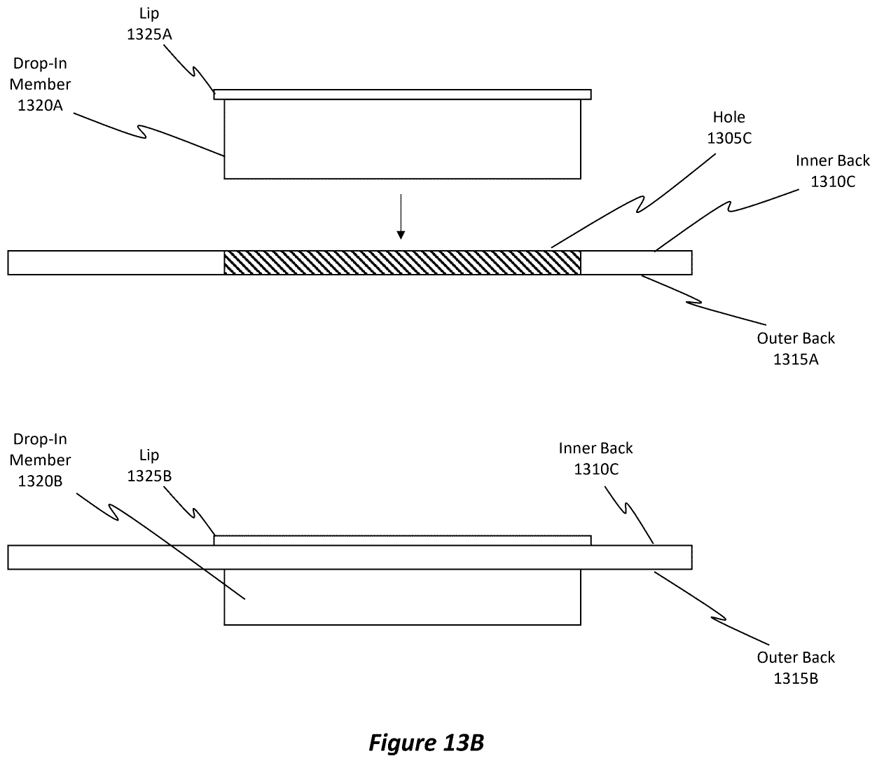

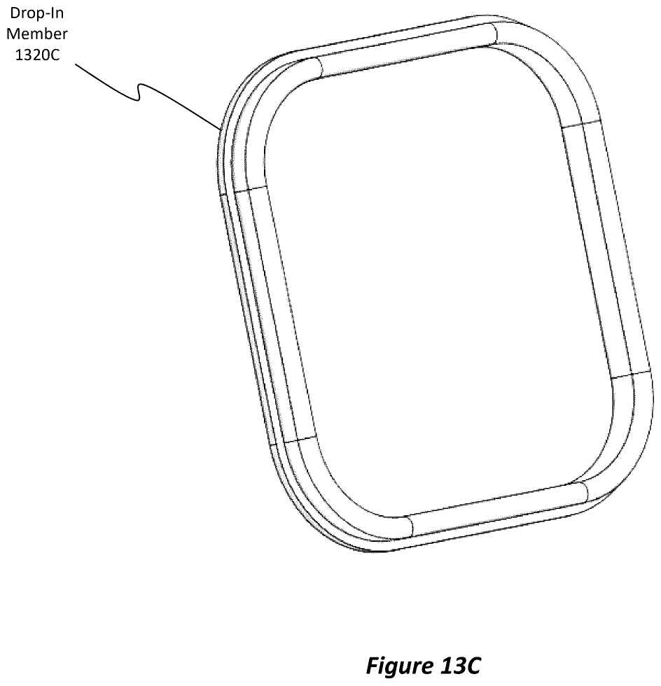

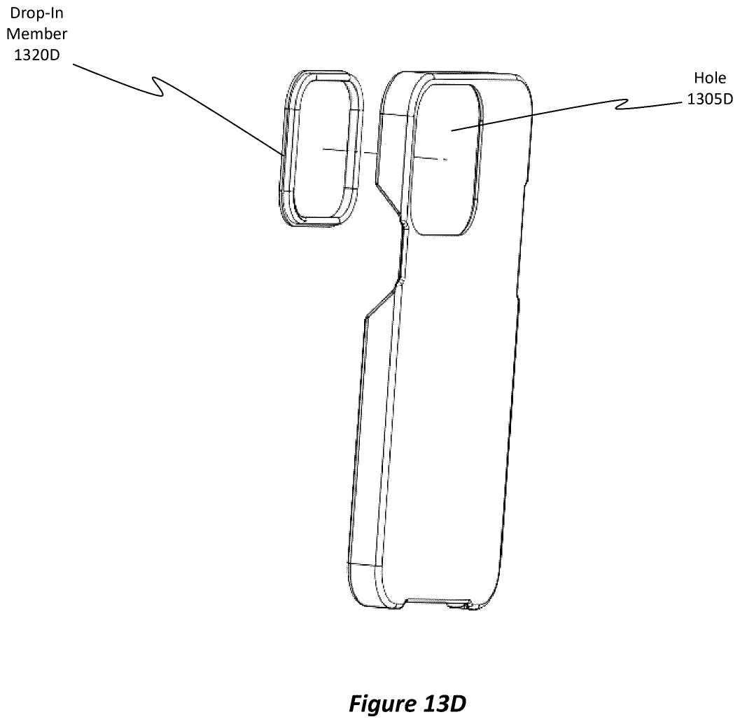

FIGS. 13A, 13B, 13C, and 13D show additional embodiments of a case that can include attachable features. FIG. 13A shows a case 1300 that includes a hole 1305A and an inner back 1310A (i.e. the inner side of the back portion of the case, or the portion of the case that is in direct contact with the device when the device is positioned in the case). FIG. 13A also shows a close-up view of the hole 1305B, which is representative of the hole 1305A, and the inner back 1310B, which is representative of the inner back 1310A. FIG. 13A shows the case 1300 at an angled side view.

FIG. 13B shows a portion of the case from a direct side view. Notice, FIG. 13B shows the inner back 1310C, which corresponds to the inner backs 1310A and 1310B. FIG. 13B also shows the outer back 1315A (i.e. the outer side of the back portion of the case or the portion of the case that is not in direct contact with the device when the device is positioned in the case). FIG. 13B also shows the hole 1305C, which is representative of the holes 1305A and 1305B.

FIG. 13B also shows a drop-in member 1320A, which can optionally be printing using the disclosed techniques as well. Drop-in member 1320A is designed to be dropped into the hole 1305C, where the drop occurs from the inner back 1310C side to the outer back 1315A side. When the case is placed on the handheld device, the device prevents the drop-in member 1320A from being dislodged or removed.

In some implementations, drop-in member 1320A includes a lip 1325A that will prevent the drop-in member 1320A from fully passing through the hole 1305C.

FIG. 13B shows a depiction in which the drop-in member 1320B is fully positioned into place within the hole. Notice, the lip 1325B is on the inner back 1310C side and is preventing the drop-in member 1320B from fully passing through the hole. This lip 1325B can optionally come into contact with the handheld device, and the device can prevent the drop-in member 1320B from moving. In some implementations, the back of the case includes a recessed portion to accommodate the lip 1325B, so that the lip 1325B of the drop-in member 1320B (when properly positioned) is flush with the inner back 1310C.

In this manner, some embodiments design holes in the case through which additional features can then subsequently pass through. It is often the case that handheld devices (e.g., a phone) includes a protruding camera or other protrusion. It is desirable to be able to protect this protrusion using the case. Using the above printing technique, additional drop-in members can be designed so as to protect the handheld device's own protrusions.

The above technique is advantages so as to reduce the amount of printing time that is required. That is, if the drop-in member were designed as an integral part of the case (as opposed to being a drop-in member), then significant design modifications would be required and significant increases in the print time and print material would occur.

By printing two units, as shown in FIG. 13B, the embodiments are able to reduce the print time and are able to more fully customize drop-in members. That is, the drop-in member can be printed on the same print bed as the case, and then the drop-in member can be easily dropped into the void or hole made within the case. Thus, any type of insertable, protective rings or other drop-in members (aka “secondary objects”) can be created and incorporated with the case. In some cases, the material forming the secondary object can be the same as the material(s) of the case. For instance, the secondary object can be formed of the hard material or of the soft material. Optionally, the secondary object can be formed of a combination of the hard material and the soft material.

The drop-in members can be designed to accommodate any objective. For instance, the drop-in member might include an eyelet to allow a user's finger to fit through it, thereby providing a handhold for the case. The drop-in member can be designed to act as an attachment mechanism to attach the case to other items as well. Indeed, the drop-in member can be designed to include any feature that is printable.

FIG. 13C illustrates another view of the drop-in member 1320C. FIG. 13D illustrates yet another view of the drop-in member 1320D being positioned into the hole 1305D.

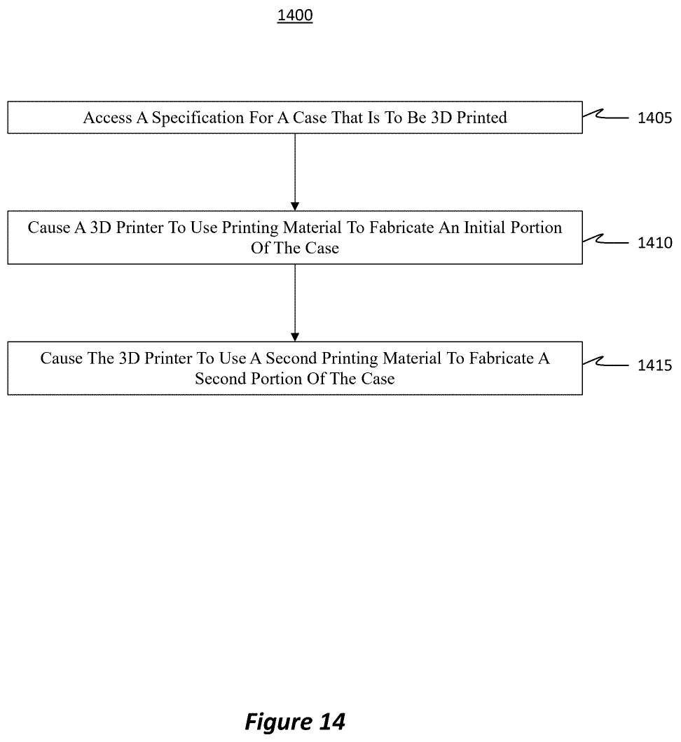

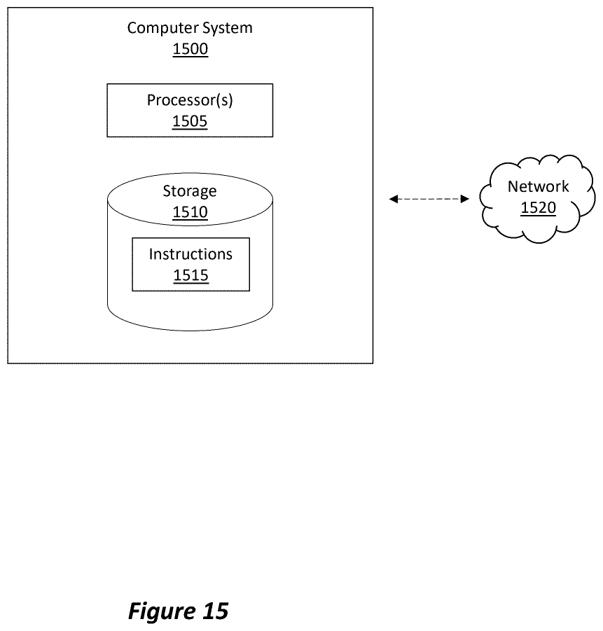

Attention will now be directed to FIG. 14, which illustrates a flowchart of an example method for implementing a three-dimensional (3D) printing operation for printing a case comprised of multiple different materials and for preventing delamination of those different materials. Method 1400 can be implemented within the architecture 100 of FIG. 1. Furthermore, method 1400 can be performed by the service 105 and the 3D printer 110.

Method 1400 includes an act (act 1405) of accessing a specification for a case that is to be 3D printed. The case is associated with a particular type of handheld device.

Based on the specification, act 1410 includes causing a 3D printer to use printing material to fabricate an initial portion of the case. The printing material used to fabricate the initial portion is made of a first type of material. The initial portion includes one or more protruding portions that provide an increased amount of surface area for the printing material.

Act 1415 includes causing the 3D printer to use a second printing material to fabricate a second portion of the case. The second printing material is made of a second type of material. The second portion is overlaid, during the fabrication process, on top of the one or more protruding portions, thereby interleaving the second printing material with the printing material. In some cases, a single layer of the case might include multiple different material types, such as material A and material B, both printed on the same case layer, as was shown in FIG. 10.

Optionally, the second printing material is relatively more flexible than the printing material. In some cases, a thickness of the one or more protruding portions is at least two layers of the printing material. In some cases, the thickness of the one or more protruding portions is about 0.4 millimeters.

In some cases, the printing material has a material hardness that is relatively harder than a hardness of the second printing material. Optionally, during the fabrication process, a relief notch can be created in the case.

In some scenarios, a secondary object is printed on the same print pad as where the case is being printed. The secondary object can be insertable into a hole formed within the case. If the secondary object includes a lip, that lip can optionally fit within a recessed portion formed in the case. That lip operates as an overhand to prevent the second object from fully passing through the hole. The secondary object can include any type of attachment mechanism and/or can include any type of printable feature (e.g., a handhold). Accordingly, the disclosed embodiments are able to print cases formed of multiple different types of materials, and the embodiments are able to facilitate this printing process in a manner so as to reduce or eliminate the likelihood that one material will delaminate from the other material.

### Example Computer/Computer Systems

Attention will now be directed to FIG. 15 which illustrates an example computer system 1500 that may include and/or be used to perform any of the operations described herein. For instance, computer system 1500 can implement the service 105 of FIG. 1 and can perform the method 800 of FIG. 8.

Computer system 1500 may take various different forms. For example, computer system 1500 may be embodied as a tablet, a desktop, a laptop, a mobile device, or a standalone device, such as those described throughout this disclosure. Computer system 1500 may also be a distributed system that includes one or more connected computing components/devices that are in communication with computer system 1500. For instance, computer system 1500 can control, include, or interact with a 3D printer.

In its most basic configuration, computer system 1500 includes various different components. FIG. 15 shows that computer system 1500 includes one or more processor(s) 1505 (aka a “hardware processing unit”) and storage 1510.

Regarding the processor(s) 1505, it will be appreciated that the functionality described herein can be performed, at least in part, by one or more hardware logic components (e.g., the processor(s) 1505). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 1500. The different components, modules, engines, and services described herein may be implemented as objects or processors that execute on computer system 1500 (e.g. as separate threads).

Storage 1510 may be physical system memory, which may be volatile, non-volatile, or some combination of the two. The term “memory” may also be used herein to refer to non-volatile mass storage such as physical storage media. If computer system 1500 is distributed, the processing, memory, and/or storage capability may be distributed as well.

Storage 1510 is shown as including executable instructions 1515. The executable instructions 1515 represent instructions that are executable by the processor(s) 1505 of computer system 1500 to perform the disclosed operations, such as those described in the various methods.

The disclosed embodiments may comprise or utilize a special-purpose or general-purpose computer including computer hardware, such as, for example, one or more processors (such as processor(s) 1505) and system memory (such as storage 1510), as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 1500 may also be connected (via a wired or wireless connection) to external sensors (e.g., one or more remote cameras) or devices via a network 1520. For example, computer system 1500 can communicate with any number devices or cloud services to obtain or process data. In some cases, network 1520 may itself be a cloud network. Furthermore, computer system 1500 may also be connected through one or more wired or wireless networks to remote/separate computer systems(s) that are configured to perform any of the processing described with regard to computer system 1500.

A “network,” like network 1520, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 1500 will include one or more communication channels that are used to communicate with the network 1520. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The disclosed embodiments can be implemented in various different configuration, as described by the clauses presented below.

Clause 1. A computer system that temporarily pauses a three-dimensional (3D) printing operation to enable a non-printing material to be disposed in a region defined during the 3D printing operation, said computer system comprising: at least one processor; and at least one hardware storage device that stores instructions that are executable by the at least one processor to cause the computer system to: access a specification for a case that is to be 3D printed; based on the specification, cause a 3D printer to use printing material to fabricate an initial portion of the case, wherein said fabrication includes fabricating an insert region into which a non-printing material can be disposed; after at least a portion of the insert region has been fabricated, temporarily pause said fabrication; determine that the non-printing material has been disposed in the insert region; and after the non-printing material has been disposed in the insert region, resume said fabrication of the case.

Clause 2. The computer system of any of the preceding clauses, wherein resuming the fabrication of the case includes causing the 3D printer to fully envelope the non-printing material with the printing material.

Clause 3. The computer system of any of the preceding clauses, wherein resuming the fabrication of the case includes causing the 3D printer to print the case in a manner such that at least a portion of the non-printing material is exposed and such that the non-printing material is not fully enveloped by the printing material.

Clause 4. The computer system of any of the preceding clauses, wherein the non-printing material is a radio frequency (RF) component.

Clause 5. The computer system of any of the preceding clauses, wherein the non-printing material is a radio-frequency (RF) blocking component.

Clause 6. The computer system of any of the preceding clauses, wherein the non-printing material is a radio-frequency (RF) enhancing component.

Clause 7. The computer system of any of the preceding clauses, wherein the non-printing material is a cushioning material.

Clause 8. The computer system of any of the preceding clauses, wherein the cushioning material includes a gel.

Clause 9. The computer system of any of the preceding clauses, wherein the insert region is one of a plurality of insert regions, and wherein a pattern of the plurality of insert regions is that of a honeycomb pattern.

Clause 10. The computer system of any of the preceding clauses, wherein the case is printed using multiple different material types.

Clause 11. A method for implementing a three-dimensional (3D) printing operation for printing a case comprised of multiple different materials and for preventing delamination of said different materials, said method comprising: accessing a specification for a case that is to be 3D printed, the case being associated with a particular type of handheld device; based on the specification, causing a 3D printer to use printing material to fabricate an initial portion of the case, wherein the printing material used to fabricate the initial portion is made of a first type of material, and wherein the initial portion includes one or more protruding portions that provide an increased amount of surface area for the printing material; and causing the 3D printer to use a second printing material to fabricate a second portion of the case, wherein the second printing material is made of a second type of material, and wherein the second portion is overlaid, during said fabrication, on top of the one or more protruding portions, thereby interleaving the second printing material with the printing material.

Clause 12. The method of any of the preceding clauses, wherein the printing material has a material harness that is relatively harder than a hardness of the second printing material.

Clause 13. The method of any of the preceding clauses, wherein the second printing material is relatively more flexible than the printing material.

Clause 14. The method of any of the preceding clauses, wherein, during said fabrication, a relief notch is created in the case.

Clause 15. The method of any of the preceding clauses, wherein, on a same print pad as where the case is being printed, a secondary object is also being printed.

Clause 16. The method of any of the preceding clauses, wherein the secondary object is insertable into a hole formed within the case.

Clause 17. The method of any of the preceding clauses, wherein a thickness of the one or more protruding portions is about 0.4 millimeters.

Clause 18. The method of any of the preceding clauses, wherein a thickness of the one or more protruding portions is at least two layers of the printing material.

Clause 19. A method for implementing a three-dimensional (3D) printing operation for printing a case comprised of multiple different materials and for preventing delamination of said different materials, said method comprising: accessing a specification for a case that is to be 3D printed, the case being associated with a particular type of handheld device; based on the specification, causing a 3D printer to use printing material to fabricate an initial portion of the case, wherein the printing material used to fabricate the initial portion is made of a first type of material, and wherein the initial portion includes one or more protruding portions that provide an increased amount of surface area for the printing material; and causing the 3D printer to use a second printing material to fabricate a second portion of the case, wherein the second printing material is made of a second type of material, and wherein the second portion is overlaid, during said fabrication, on top of the one or more protruding portions, thereby interleaving the second printing material with the printing material, wherein the second printing material is relatively more flexible than the printing material, and wherein a thickness of the one or more protruding portions is at least two layers of the printing material.

Clause 20. The method of any of the preceding clauses, wherein said thickness is about 0.4 millimeters.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system that temporarily pauses a three-dimensional (3D) printing operation to enable a non-printing material to be disposed in a region defined during the 3D printing operation, said computer system comprising:
at least one processor; and
at least one hardware storage device that stores instructions that are executable by the at least one processor to cause the computer system to:
access a specification for a case that is to be 3D printed;
based on the specification, cause a 3D printer to use printing material to fabricate an initial portion of the case, wherein said fabrication includes fabricating an insert region into which a non-printing material can be disposed;
after at least a portion of the insert region has been fabricated, temporarily pause said fabrication;
determine that the non-printing material has been disposed in the insert region; and
after the non-printing material has been disposed in the insert region, resume said fabrication of the case.

2. The computer system of claim 1, wherein resuming the fabrication of the case includes causing the 3D printer to fully envelope the non-printing material with the printing material.

3. The computer system of claim 1, wherein resuming the fabrication of the case includes causing the 3D printer to print the case in a manner such that at least a portion of the non-printing material is exposed and such that the non-printing material is not fully enveloped by the printing material.

4. The computer system of claim 1, wherein the non-printing material is a radio frequency (RF) component.

5. The computer system of claim 1, wherein the non-printing material is a radio-frequency (RF) blocking component.

6. The computer system of claim 1, wherein the non-printing material is a radio-frequency (RF) enhancing component.

7. The computer system of claim 1, wherein the non-printing material is a cushioning material.

8. The computer system of claim 7, wherein the cushioning material includes a gel.

9. The computer system of claim 1, wherein the insert region is one of a plurality of insert regions, and wherein a pattern of the plurality of insert regions is that of a honeycomb pattern.

10. The computer system of claim 1, wherein the case is printed using multiple different material types.

11. A method for implementing a three-dimensional (3D) printing operation for printing a case comprised of multiple different materials and for preventing delamination of said different materials, said method comprising:
accessing a specification for a case that is to be 3D printed, the case being associated with a particular type of handheld device;
based on the specification, causing a 3D printer to use printing material to fabricate an initial portion of the case, wherein the printing material used to fabricate the initial portion is made of a first type of material, and wherein the initial portion includes one or more protruding portions that provide an increased amount of surface area for the printing material; and
causing the 3D printer to use a second printing material to fabricate a second portion of the case, wherein the second printing material is made of a second type of material, and wherein the second portion is overlaid, during said fabrication, on top of the one or more protruding portions, thereby interleaving the second printing material with the printing material.

12. The method of claim 11, wherein the printing material has a material hardness that is relatively harder than a hardness of the second printing material.

13. The method of claim 11, wherein the second printing material is relatively more flexible than the printing material.

14. The method of claim 11, wherein, during said fabrication, a relief notch is created in the case.

15. The method of claim 11, wherein, on a same print pad as where the case is being printed, a secondary object is also being printed.

16. The method of claim 15, wherein the secondary object is insertable into a hole formed within the case.

17. The method of claim 11, wherein a thickness of the one or more protruding portions is about 0.4 millimeters.

18. The method of claim 11, wherein a thickness of the one or more protruding portions is at least two layers of the printing material.

19. A method for implementing a three-dimensional (3D) printing operation for printing a case comprised of multiple different materials and for preventing delamination of said different materials, said method comprising:
accessing a specification for a case that is to be 3D printed, the case being associated with a particular type of handheld device;
based on the specification, causing a 3D printer to use printing material to fabricate an initial portion of the case, wherein the printing material used to fabricate the initial portion is made of a first type of material, and wherein the initial portion includes one or more protruding portions that provide an increased amount of surface area for the printing material; and
causing the 3D printer to use a second printing material to fabricate a second portion of the case, wherein the second printing material is made of a second type of material, and wherein the second portion is overlaid, during said fabrication, on top of the one or more protruding portions, thereby interleaving the second printing material with the printing material,
wherein the second printing material is relatively more flexible than the printing material, and wherein a thickness of the one or more protruding portions is at least two layers of the printing material.

20. The method of claim 19, wherein said thickness is about 0.4 millimeters.
